(19) United States
(12) Patent Application Publication
(10) Pub. No.: US 2016/0381171 A1
(43) Pub. Date: Dec. 29, 2016

(54) FACILITATING MEDIA PLAY AND REAL-TIME INTERACTION WITH SMART PHYSICAL OBJECTS

(71) Applicant: INTEL CORPORATION, Santa Clara, CA (US)

(72) Inventors: GLEN J. ANDERSON, Beaverton, OR (US); MARK R. FRANCIS, Portland, OR (US); RAVISHANKAR IYER, Portland, OR (US); YEVGENIY Y. YARMOSH, Portland, OR (US); KEVIN W. BROSS, Tigard, OR (US)

(73) Assignee: INTEL CORPORATION, Santa Clara, CA (US)

(21) Appl. No.: 14/747,669

(22) Filed: Jun. 23, 2015

(51) Int. Cl. H04L 29/08

(52) U.S. Cl. CPC H04L 67/306; H04L 67/1097

(57) ABSTRACT

A mechanism is described for dynamically facilitating media play and real-time interaction with smart physical objects according to one embodiment. A method of embodiments, as described herein, includes seeking one or more personal devices accessible to one or more users; presenting media contents; detecting, in real-time, an update relating to the media contents; recommending one or more revisions to activities or arrangements relating to the one or more personal devices based on the update relating to the media contents; preparing a set of instructions detailing the one or more revisions to the activities or the arrangements; and executing the set of instructions to facilitate the one or more revisions to the activities or the arrangements relating to the one or more personal devices.

### FIELD

Embodiments described herein generally relate to computers. More particularly, embodiments relate to dynamically facilitating media play and real-time interaction with smart physical objects.

### BACKGROUND

Although increasing number of toys include embedded movement and communication features, these toys are severely limited in the use and application of such features. For example, despite advancements in media technology, such toys still lack direct linking with media devices.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a real-time media play and interactive communication mechanism according to one embodiment.

FIG. 2 illustrates a real-time media play and interactive communication mechanism according to one embodiment.

FIG. 3 illustrates an architectural scenario according to one embodiment.

FIG. 4A illustrates a method for facilitating real-time media play and interaction between media and personal devices according to one embodiment.

FIG. 4B illustrates a method for facilitating real-time media play and interaction between media and personal devices according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for directly linking one or more media sources or devices (e.g., computing devices, televisions, display areas, projection screens, etc.) with one or more smart physical objects (e.g., toys, games, sports gear, office equipment, household items, work tools, etc.) over a communication medium (e.g., communication channels or networks, such as a proximity network, a Cloud network, the Internet, etc.) for allowing opportunities for the physical objects and media devices to directly and interactively communicate with each other and dynamically or on-demand perform various tasks in real-time. This technique may be particularly useful with computing devices having a system on (a) chip (also referred to as “SoC” or “SOC”) and/or embedded sensing and wireless connectivity.

It is contemplated and to be noted that communication messages between one or more media sources/devices and one or more physical objects may include any number and type of messages, such as video messages, audio messages, images, text messages, hybrid messages (e.g., audio/video combined), transforming messages (e.g., voice to text or vice versa, etc.), canned or predetermined messages, any form of gestures, and/or the like. Further, this connection and communication may be performed using one or more techniques and based on one or more factors, such as context, security, etc.

In one embodiment, media (e.g., movies, shows, games, concerts, lectures, etc.), including any number and type of live or recorded media, may be broadcast directly by a media source (e.g., media broadcasters, media producers, media distributors, cable companies, satellite companies, media channels, etc.) or played locally, such as using a media player (e.g., Blu-ray disk (BD) players, digital video disc (DVD) players, compact disk (CD) players, etc.).

It is contemplated that embodiments are not limited to any number or type of smart physical objects, such as toys, games, sports gear, office equipment, household items, work tools, etc.; however, for the sake of brevity, clarity, and ease of understanding, terms like “physical object”, “smart physical object”, “personal device”, “smart personal device”, “toy”, “smart toy”, “game”, “smart game”, and/or the like, are referenced interchangeably throughout this document.

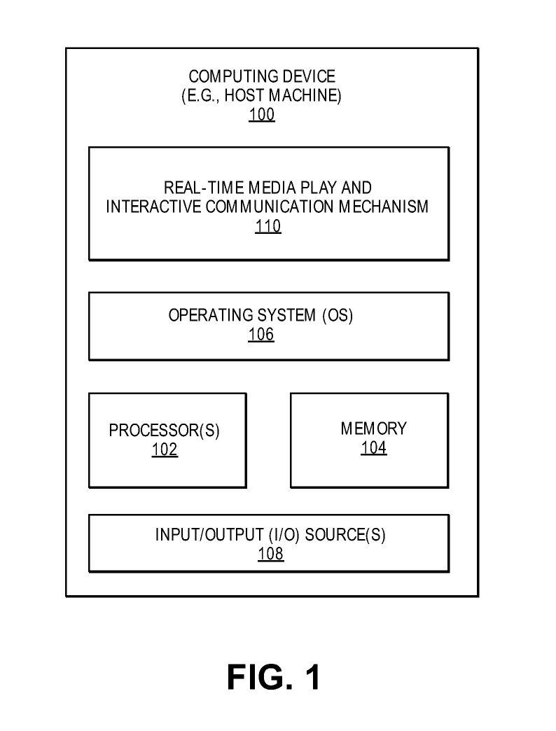

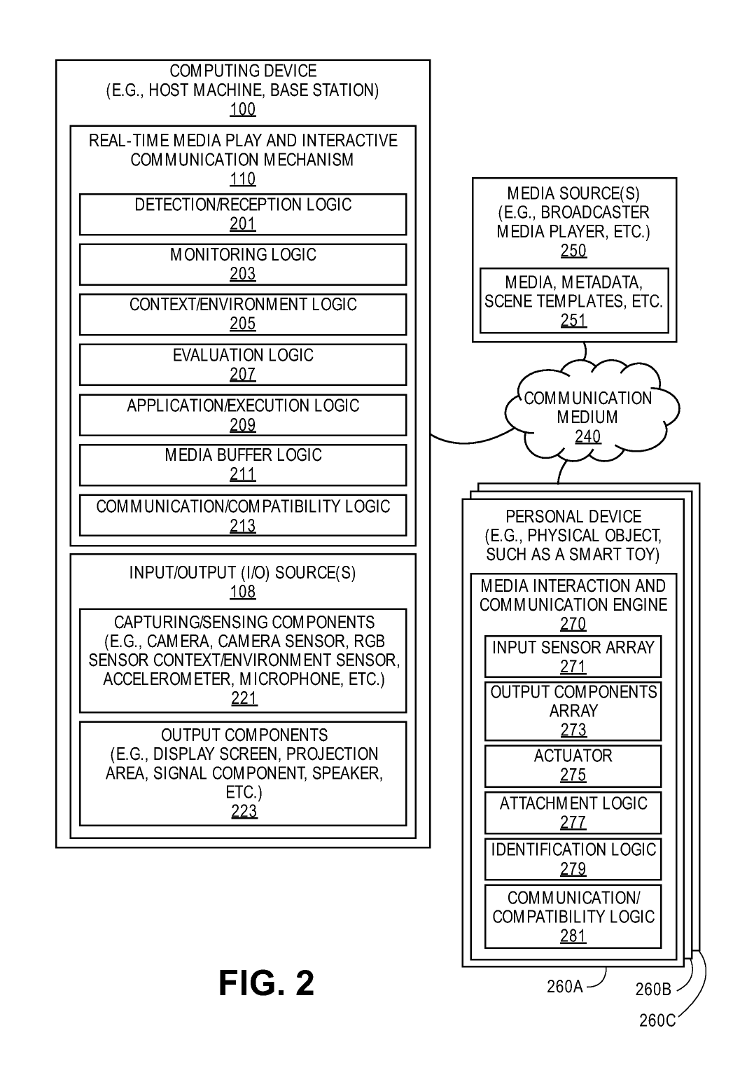

FIG. 1 illustrates a computing device 100 employing a real-time media play and interactive communication mechanism 110 according to one embodiment. Computing device 100 serves as a host machine for hosting real-time media play and interactive communication mechanism (“media mechanism”) 110 that includes any number and type of components, as illustrated in FIG. 2, to efficiently employ one or more components to facilitate dynamic and runtime communication between computing device 100 (e.g., host machine, base toy station, etc.), physical objects/personal devices (e.g., toys, games, etc.), and/or media sources (e.g., broadcaster, etc.) as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, such as Google® Glass™, head-mounted binoculars, gaming displays, military headwear, etc.), and other wearable devices (e.g., smartwatches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates a real-time media play and interactive communication mechanism 110 according to one embodiment. In one embodiment, media mechanism 110 may include any number and type of components, such as (without limitation): detection/reception logic 201; monitoring logic 203; context/environment logic 205; evaluation logic 207; application/execution logic 209; media buffer logic 211; and communication/compatibility logic 213. In one embodiment, computing device 100 further includes input/out sources 108 including capturing/sensing components 221 and output components 223.

Computing device 100 may be in communication with media source(s) 250 (e.g., media broadcasters, media players, databases, data sources, third-party computing devices, etc.) over communication medium 240 (e.g., communication channels or networks, such as Cloud network, the Internet, proximity network, etc.) and further in communication with one or more personal devices 260A, 260B, 260C (e.g., toys, games, office equipment, work tools, household items, etc.) over communication medium 240. As aforementioned, term “physical object” may be interchangeably referred to as “personal device” or “toy” throughout most of the rest of this document.

In one embodiment, media source(s) 250 may offer or provide media contents 251, such as media, metadata, and scene templates, etc., to be communicated, over communication medium 240, to media mechanism 110 through one or more components, such as detection/reception logic 201, media buffer logic 211, communication/compatibility logic 213. Further, in one embodiment, personal devices 260A-260C, such as personal device A 260A, may include media interaction and communication engine (“media engine”) 270 including one or more components, such as (without limitation): input sensors array (“input array”) 271; output components array (“output array”) 273; actuator 275; attachment logic 277; identification logic 279; and communication logic 281.

As an initial matter, as illustrated and in one embodiment, computing device 100 is shown to host media mechanism 110; however, it is contemplated that in some embodiment, one or some or all of the components of media mechanism 110 may be hosted by multiple computers and one or more third-party server computers, etc. For example, computing device 100 may include any number and type of computing devices, such as server computers, desktop computers, laptop computers, mobile or wearable computers, such as tablet computers, smartphones, smartcards, wearable glasses, smart jewelry, smart clothing items, etc.

As illustrated and in one embodiment, media source(s) 250 may be separately and remotely located (e.g., cable headend/broadcaster, broadcast channel, server computer, etc.) while staying in communication with media mechanism 110 at computing device 100 over communication medium 240, such as a Cloud network, the Internet. In another embodiment, media source(s) 250 may be separately but locally situated (e.g., server computer, laptop computer, tablet computer, etc.) while in communication with computing device 100 (e.g., DVD player, etc.) over communication medium 240, such as a proximity network, the Internet, etc. In yet another embodiment, media source(s) 250 may be part of or hosted by computing device 100 (e.g., DVD player, BD player, website, such as Netflix®, etc.).

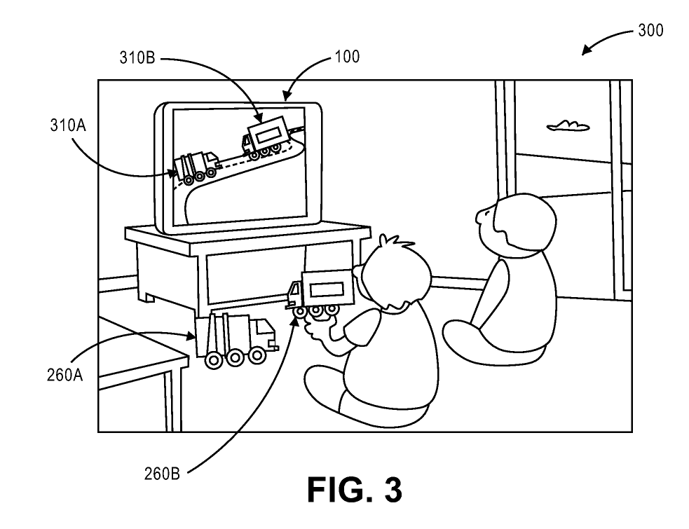

It is further contemplated and to be noted that personal devices 260A-260C may refer to or include computing devices having all their components, such as processor(s) 102, memory 104, operation system 106, etc., as illustrated with reference to FIG. 1. For example, personal device 260A may refer to or include a smart toy (e.g., a toy truck, a toy car, a toy animal, a smart game, etc.) as shown with reference to FIGS. 3A-3B.

In one embodiment, media source(s) 250 may include one or more repositories or data sources or databases to obtain, communicate, store, and maintain any amount and type of data (e.g., media, scene templates, metadata, real-time data, historical contents, user and/or device identification and other information, resources, policies, criteria, rules and regulations, upgrades, etc.). Further, in another embodiment, media source(s) 250 may include one or more computing device, such as third-party computing device, to serve as one or more media source(s) 250 to obtain, communicate, store, and maintain any amount and type of the aforementioned data, such as media, scene templates, metadata, real-time data, historical contents, user and/or device identification and other information, etc.). In some embodiments, communication medium may include any number and type of communication channels or networks, such as Cloud network, the Internet, intranet, Internet of Things (“IoT”), proximity network, Bluetooth, etc.). It is contemplated that embodiments are not limited to any particular number or type of computing devices, media sources, databases, personal devices, networks, etc.

As previously disclosed, computing device 100 may include a computer that is physically placed somewhere and belongs to a service provider or host (such as a server computer belonging to a service provider of a daycare center for children, a household computer belonging to a host of a house party, etc.), a personal device, such as a tablet computer, that the user (e.g., child) of personal device 260A (e.g., toy) may bring to the daycare center to use with personal device 260A. Accordingly, as aforementioned, embodiments are not limited to any particular number or type of computing devices, personal devices, media sources, etc., or any particular implementation or communication manners.

Computing device 100 may further include I/O sources 108 having any number and type of capturing/sensing components 221 (e.g., sensor array (such as context/context-aware sensors and environmental sensors, such as camera sensors, ambient light sensors, Red Green Blue (RGB) sensors, etc.), depth sensing cameras, two-dimensional (2D) cameras, three-dimensional (3D) cameras, image sources, audio/video/signal detectors, microphones, eye/gaze-tracking systems, head-tracking systems, etc.) and output components 223 (e.g., audio/video/signal sources, display planes, display panels, display screens/devices, projectors, display/projection areas, speakers, etc.).

Capturing/sensing components 221 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing components 221 may further include one or more of supporting or supplemental devices for capturing and/or sensing of data, such as illuminators (e.g., infrared (IR) illuminator), light fixtures, generators, sound blockers, etc.

It is further contemplated that in one embodiment, capturing/sensing components 221 may further include any number and type of context sensors (e.g., linear accelerometer) for sensing or detecting any number and type of contexts (e.g., estimating horizon, linear acceleration, etc., relating to a mobile computing device, etc.). For example, capturing/sensing components 221 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

Further, for example, capturing/sensing components 221 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components 221 may further include voice recognition devices, photo recognition devices, facial and other body recognition components, voice-to-text conversion components, etc.

Computing device 100 may further include one or more output components 223 in communication with one or more capturing/sensing components 221 and one or more components of media mechanism 110 for facilitating playing and/or visualizing of varying contents, such as images, videos, texts, audios, animations, interactive representations, visualization of fingerprints, visualization of touch, smell, and/or other sense-related experiences, etc. For example, output components 223 may further include one or more telepresence projectors to project a real image's virtual representation capable of being floated in mid-air while being interactive and having the depth of a real-life object.

Further, output components 223 may include tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output components 223 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

In one embodiment, detection/reception logic 201 may be used to perform any number and type of detection and/or reception tasks in cooperation with one or more capturing/sensing components 221, output components 223, and one or more components of media mechanism 110 to detect media contents 251 (e.g., media, metadata, scene templates), user requests, real-time data, historical monitoring data, real-time data, personal devices 260A-260C, users associated with personal devices 260A-260C, media source(s) 250, communication medium 240, and/or the like. For example, once a request (e.g., user request placed through personal device 260A) is received at detection/reception logic 201, subsequent processes may be triggered by one or more components of media mechanism 110 and/or media engine 270.

For example and in one embodiment, actions of various characters in a scene from a movie or television show, as provided by media source(s) 250, may be correlated to the activity of real/physical toys 260A-260C (e.g., toy characters) with embedded sensors, such as input array 271, actuators 275, etc., of media engine 270. In such a case, media contents 251 relating to the scene from the movie or television show may be provided by media source(s) 250 and received at detection/reception logic 201. Similarly, toys 260A-260C may be detected by detection/reception logic 201 which then provides the relevant information to monitoring logic 203 to, if necessary, monitor toys 260A-260C and the user's behavior as it relates to toys 260A-260C, such as whether the user adds an attachment, such a gun put in the hand of a toy character, such as toy 260A, etc., which may then be detected by attachment logic 277 and monitored by monitoring logic 203 over communication medium 240.

In one embodiment, toys 260A-260C may act or perform (e.g., flipping over, turning left, fighting with each other, etc.) in accordance with the scene being performed by the corresponding virtual characters as displayed by a display screen of output components 223 of computing device 100 and communicated with media engine 270 at toys 260A-260C via input array 271 and communication logic 281 (e.g., wireless communication components). For example, input array 271 and output array 273 of personal devices 260A may include the same components as capturing/sensing components 221 and output components 223, respectively, of computing device 100.

It is contemplated that media of media contents 251 may include any amount and type of diverse media, such as television (TV) shows, movies, talk shows, cartoons, sitcoms, game shows, teaching/learning shows, instructions, announcements, radio/audio shows, and/or the like. However, for the sake of brevity, clarity, and ease of understanding, TV shows are used as examples for various use case scenarios throughout this document; however, it is to be noted that embodiments are not limited as such.

For example and in one embodiment, a TV show, obtained from media source(s) 250 and played at computing device 100, such as using a display screen of output components 223, may be used to automatically alter one or more toys 260A-260C in one way or another (such as flip over a toy truck, increase speed of a toy car, one toy character fights with another toy character, pull apart a spring of a toy car in response to an explosion shown on the TV show that destroys its on-screen car corresponding to the toy car, etc.) by triggering actuator 275 at one or more toys 260A-260C that correspond to the TV show's on-screen characters.

Similarly, in one embodiment, a scene from the TV show may be automatically queued up to play when a user perform actions with one of toys 260A-C that correlates with actions of a corresponding character in a scene of the TV show, where this may include a single toy interaction, such as the user making toy 260A run faster, or a multiple toy interaction, such as the user racing a couple of toy cars, such as toys 260A and 260B.

In one embodiment, arrangement logic 277 may be used to recognize and use one or more components that may be attached to and used with toys 260A-260C, such as a sword may be put into a hand of a fighting character, a container may be added to a truck, a second engine may be detached from a train, a costume may be put on a superhero character, etc. These assembly options for toys 260A-260C, when exercised, may alter the media playing in one or more ways, such as if a child adds additional protective shield and/or a weapon to a warrior figurine, such as toy 260A, representing a corresponding warrior character on the TV show may trigger a new scene, episode, and/or version of the TV show on computing device 100.

Continuing with the example above, in one embodiment, the attaching of the protective shield or weapon to toy 260A may be detected by input array 271 and recognized by attachment logic 277 and then communicated on to detection/reception logic 201 of media mechanism 110 via communication logic 281. In another embodiment, toy 260A may be continuously, in runtime, monitored by monitoring logic 203 and thus any such change or alternation in toy 260A may be monitored by monitoring logic 203 by being in communication with attachment logic 277 over communication medium 240 and via communication/compatibility logic 213 and/or communication logic 281. Either way, this information regarding the new attachment, reflecting a change in toy 260A, may then be communicated by detection/reception logic 201 and/or monitoring logic 203 to evaluation logic 207 for further processing.

At evaluation logic 207, this change may be evaluated with respect to the TV show to determine whether a change in the TV show is necessitated. For example, if the TV show is a series and currently playing Episode 2 of Season 1 and that the character corresponding to toy 260A wears the shield and/or holds the weapon in a later episode of a subsequent season, such as Episode 7 of Season 2, evaluation logic 207 may consider the change in toy 260A as an indication from the user of toy 260A to move the episode forward that later episode and this consideration may then be forwarded on to application/execution logic 209. In one embodiment, application/execution logic 209 applies the results based on the determination obtained from evaluation logic 207 and executes the task to move the TV show forward to the relevant Episode 7 of Season 2. In another embodiment, the TV show may be moved forward or backwards to another scene, episode, release, version, or in some embodiments, an entirely different show or movie, etc.

In some embodiments, the TV show may automatically pause to give instructions to the use if, for example, an episode reaches a point where it may be necessary, productive, or customary to play these instructions to one or more users of one or more of toys 260A-C so they may create or recreate a scene with their toys 260A-260C that may correspond with the scene being or about to be played on the TV show corresponding to the characters of the relevant toys 260A-260C. These instructions may include directions regarding positions, movements, and/or interaction relating to the relevant of toys 260A-C, where, for example, automatically or manually, the relevant of toys 260A-C are expected to comply with the instructions.

It one embodiment, these instructions may be communicated to the user through one or more output components 223, such as display screens, speakers, etc., of computing device 100 and/or through output array 273 of the relevant of toys 260A-260C. As aforementioned, in one embodiment, upon receiving the instructions, the user may manually alter the relevant toy, such as toy 260A, while, in another embodiment, upon detecting the instruction, actuator 275 at the user's toy 260A may be triggered to dynamically and automatically make relevant changes to toy 260A or the scene surrounding toy 260A, such as flip over or speed up toy 260A, move toy 260A in closer proximity to toy 260B, add attachments to one or more toys 260A-C or remove such attachments, etc.

Further, in one embodiment, the aforementioned instructions may be altered based on various factors, such as the user's age, experience, talent level, difficulty level, etc., where such factors may be continuously or periodically monitored by monitoring logic 203, received by detection/reception logic 201 as inputted by the user via a user interface provided through input array 270, and/or detected by context/environment logic 205, etc. These factors may then be considered and evaluated by evaluation logic 207 before having application/execution logic 209 generate the instructions and execute them to be communicated through one or more output components 223 as facilitated by communication/compatibility logic 213.

Similarly, in one embodiment, toys 260A-260C may be used to alert or reminder the corresponding users, such as by barking, talking, playing music or tunes, etc., when it is time for a particular broadcast (e.g., a new episode of the TV show) to be played on computing device 100 or to perform a task (e.g., adding/removing attachments, etc.) on toys 260A-260C, etc. For example, in case of a new broadcast, toys 260A-260C on computing device 100, it may be communicated on to or detected by one or more of input array 271 and then the alert/reminder may be played by one or more of output array 273.

In some cases where the user of a toy, such as toy 260A, may lack or run short of one or more attachments (e.g., toy train cars, toy truck containers, toy weapons, toy car wheels, etc.) or another toy, such as 260B, to create or recreate a scene, evaluation logic 207 may determine this deficiency and facilitate application/execution logic 209 to put together a sales offer to the user for the missing items. For example, upon detecting the deficiency, evaluation logic 207 instructs application/execution logic 209 to prepare and offer the user an opportunity to purchase one or more of the missing items, such as by displaying a sales offer on a display screen of output components 223.

In one embodiment, media buffer logic 211 may be used to buffer-in/out the various media contents 251 received from media source(s) 250, where such media contents 251 may include (without limitation) media (e.g., programs, shows, movies, advertisements, etc.), metadata (e.g., information relating to the media), and scene templates (e.g., scene template to allow for monitoring or tracking of progression of actions by toys 260A-C to match one or more parts of a scene, etc.), etc.

Moreover, in one embodiment, TV shows, movies, etc., may be prepared with additional metadata to track actions of various characters within the scenes of those TV shows, movies, etc., and this metadata may be communicated from media source(s) 250 to media mechanism 110 through media buffer logic 211. For example, this metadata could be added with other types of metadata during production of such shows, movies, etc., and similarly, video analysis may be run on the video in post-production to estimate various attributes, such as velocity of movements of characters, dialog between characters, intersections between characters, amplitude of movements of characters, etc. Examples of metadata may include (without limitation); toy character 1 260A touches toy character 2 260B; toy character 1 260A crashes with an amplitude of at least 5 units; toy character 2 260B flips 3 times; toy character 1 260A says “help”; and toy character 2 260B wears a red hat, and/or the like.

In some embodiments, metadata may be added to various TV shows, movies, etc., at various stages, such as during pre-production, production, post-production, broadcast, post-broadcast, etc., and communicated from one or more relevant media source(s) 250 to media mechanism 110 through media buffer as facilitate media buffer logic 211. In some embodiment, context/environment logic 205 along with one or more capturing/sensing components 221 may be used to detect, monitor, and collect any amount and type of data (such as data associated with behavior, context, environment, etc.) relating to toys 260A-260C and their corresponding users, etc., which may then be communicated back to media source(s) 250 for use as metadata in current and/or future broadcasts, etc.

In one embodiment, metadata may be encapsulated within scenes or parts of scenes, such that in some embodiments, metadata-based scene templates may be created at media source(s) 250 and forwarded on to media mechanism 110 through media buffer 211 to allow for monitoring logic 203 to track, for example, progression of actions associated with or performed by toys 260A-260C to match various parts of the scenes. For example, a scene template may be used to provide and facilitate a series of actions that a character in a TV show may perform within a period of time, such as 10 seconds, in a single scene, where the metadata for that period of time may be copied to the scene template. Continuing with the example, the scene template may include one or more actions, such as (without limitation) toy character 1 260A moves in a circle, toy character 2 260B flips over 3 times and screams “I'm hungry!”, and/or the like.

Similarly, in some embodiments, the relevant metadata may include control points in the video, where these control points may be applied and executed such that the video may be made to pause and wait for an input from one or more toys 260A-260C. Further, in one embodiment, after monitoring logic 203 has determined that in response to the scene template, the user has moved a corresponding toy 260A in an arc (progressing towards the circle), turned it over multiple times, and said a phrase that nearly matches “I'm hungry!”, the user may then be provided some positive feedback via one or more output components 223 to inform or encourage the user for their proper actions with regard to toy 260A and in compliance with the scene template and subsequently, the video may continue to broadcast. Further, a scene template may include a list of matching toy actions that monitoring logic 203 may track for their performance and completion.

In one embodiment, toys 260A-260C may include identification logic 279 to communicate or report identification (ID) for each of toys 260A-260C, where each ID may correspond to a character in the TV show and as it relates to toys 260A-C. Further, each toy 260A-260C and its add-on attachments may include an embedded ID tag, such as Radio Frequency ID (RFID) tag, which may be known to identification logic 279 and used by detection/reception logic 201 for identification and verification purposes. Further, for example, when the TV show pauses, any instructions (e.g., assembly instructions) may direct the users to assemble their physical toys 260A-260C that match the characters in the scene while, in one embodiment, monitoring logic 203 may monitor their presence. Further, as previously mentioned, certain missing parts, such as those needed for assembly of toys 260A-260C, may be offered to the users through sales offers using one or more output components 223 of computing device 100. In some embodiments, these IDs may be stored or maintained at media source(s) 250 and/or one or more databases or storage devices associated with computing device 100. Further, for example, media buffer logic 211 of media mechanism 110 may be used to facilitate storage and communication of these IDs between toys 260A-C, computing device 100, and media source(s) 250.

In some embodiments, a database of characteristic movements of physical toys 260A-C may be developed prior to selling or providing toys 260A-260C to customers/users and subsequently and continuously, updates may be obtained over time to keep the database updated which may be stored at media source(s) 250. Further, monitoring logic 203 along with any number and type of components, such as motion sensors, accelerometer, gyroscope, etc., of capturing/sensing components 221 may be used for developing accelerometer and gyroscope profiles for various types of events, such as sudden stops after reaching a certain velocity or speed, flips and tips, riding on two wheels as opposed to four wheels, parts/attachments being removed or added, etc.

In one embodiment, actuator 275 embedded at toys 260A-260C may be used for allowing toys 260A-260C to respond to various commands (e.g., action instructions, movement instructions, assembly instructions, announcements, etc.) that are issued from media mechanism 110, such as in accordance with the metadata within the video as provided by media source(s) 250 through media buffer logic 211. For example, a mechanical switch may be used to release a spring-loaded part at one or more toys 260A-260C to match the destruction of the corresponding character on a TV show, or a toy car, such as toy 260A, or accelerate and turn toy 260A hard enough to cause it to flip over to match the flipping over of its corresponding character on the TV show.

Further, monitoring logic 203 may be used to detect and monitor, in real-time, the proximity of toys 260A-260C, such as with regard to each other, as their users create or recreate various scenes using their toys 260A-260C. For example, in one embodiment, this proximity may be monitored by monitoring logic 203 in any number and type of ways, such as conductance, reed switches (e.g., magnetic), near field communication (NFC), proximity networks (e.g., Bluetooth), video analytics, etc., where proximity sensors may be part of sensor array of input array 271 at toys 260A-260C and/or capturing/sensing components 221 of computing device 100.

As users of toys 260A-260C mimic dialogs being played on TV shows, such dialogs may be detected through microphones that are embedded as part of capturing/sensing components 221 and/or input array 271. Similarly, in one embodiment, these microphones and other relevant sensors of capturing/sensing components 221 and/or input array 271 may be used for performing speech recognition that provides additional functionalities for voice processing and analysis, etc., to provide additional benefits and accuracy in matching the users' voices with those of the characters on various TV shows, movies, games, etc.

It is contemplated and as aforementioned, users may be allowed to modify their toys 260A-260C using any number and type of add-on items, such as parts, attachments, etc., where, in one embodiment, each of these parts, attachments, add-ons, etc., may have a built-in ID that may be detected or recognized by identification logic 279 and communicated over to media mechanism 110 at computing device 100 and then over to media source(s) 250. In another embodiment, various other components, such as cameras, camera sensors, video analytic sensors, etc., of input array 271 and/or capturing/sensing components 221 may be used for detecting and determining various add-on attachments by, for example, visualizing them as being attached to or removed from toys 260A-260C. For example, as the user of a toy truck, such as toy 260A, chooses to modify toy 260A by replacing its regular tires with special winter/snow tires for better achieving traction in snow or on wintery roads, this act of adding/removing tires may be detected, in one embodiment, through detecting and identifying the IDs embedded in those added/removed tires using identification logic 279 or, in another embodiment, capturing the act using a camera, etc., of input array 271.

Further, in one embodiment, these add-on attachment tasks may be tracked or monitored using monitoring logic 203, where these add-on components or attachments may be plugged into prenatal control/award systems established for awarding the users, such as a child/user may be rewarded for performing a chore or receiving good grades by getting an add-on attachment that (once successfully installed on toys 260A-260C) may mean allowing the user to watch another episode of the show or receive another add-on, etc.

Moreover, each of toys 260A-260C may include any number and type of input components, such as microphones, touch screens, light inputs, etc., provided through input array 271 of toys 260A-260C. For example, in one embodiment, if the user recreates a high-enough fidelity scene with a real toy, such as toy 260A, a speaker of output components 223 and/or output array 273 may play a dialog from the TV show for toy 260A correlating the dialog of the character on the TV show. In another embodiment, a display screen of output components 223 and/or output array 273 may display the face of the character reflecting the changing facial expressions and movements in accordance with the facial expressions and movements of the user of toy 260A.

It is contemplated that media being obtained from media source(s) 260 through media buffer logic 211 may be any amount and type of media, such as live broadcast, streaming, or audio only, etc., and similarly, toys 260A-260C may include any number and type of sensors provided through input array 271, such as motion sensors, 2D cameras, 3D cameras, IR cameras, light sensors, microphones, etc. It is further contemplated that input array 271 and output array 273 may include any number and type of the aforementioned components of capturing/sensing components 221 and output components 223, respectively.

It is further contemplated that the order of events may vary in any manner, such as actuator 275 at toy 260A may initiate an event when two toys, such as toy 260A and 260B, are within a given proximity of each other as, for example, in simulation of two toy trucks crashing into each other on the TV show, etc. As mentioned above, personal devices 260A-C are not limited to merely toys or any particular type of toys, such as cars with race tracks, Beyblade™ (where spinning tops fight and battle each other), dolls, figurines of characters (e.g., people, animals, inanimate objects), race cars, trains, stuff animals, etc.

Communication/compatibility logic 213 may be used to facilitate dynamic communication and compatibility between computing device 100 and personal devices 260A-260C, media source(s) 250, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “media”, “metadata”, “scene template”, “physical object”, “personal device”, “toy”, “TV show”, “participating device”, “personal device”, “smart device”, “mobile computer”, “wearable device”, etc., should not be read to limit embodiments to software or devices that carry that label in products or in literature external to this document.

It is contemplated that any number and type of components may be added to and/or removed from media mechanism 110 to facilitate various embodiments including adding, removing, and/or enhancing certain features. For brevity, clarity, and ease of understanding of media mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3 illustrates an architectural scenario 300 according to one embodiment. As an initial matter, for brevity, clarity, and ease of understanding, many of the components and processes discussed above with reference to FIGS. 1-2 may not be repeated or discussed hereafter. It is contemplated and to be noted that embodiments are not limited to the illustrated architectural scenario 300.

In the illustrated embodiment, scenario 300 is shown to include personal devices 260A, 260B (e.g., toy trucks) correlating with the two corresponding media characters 310A, 310B shown on a display device of a computing device 100, such as a television. For example, as illustrated, if the two characters 310A, 310B on the screen move towards collision or passing each other, the two physical toys 260A, 260B may also correspondingly collide or pass each other as further described with reference to FIG. 2.

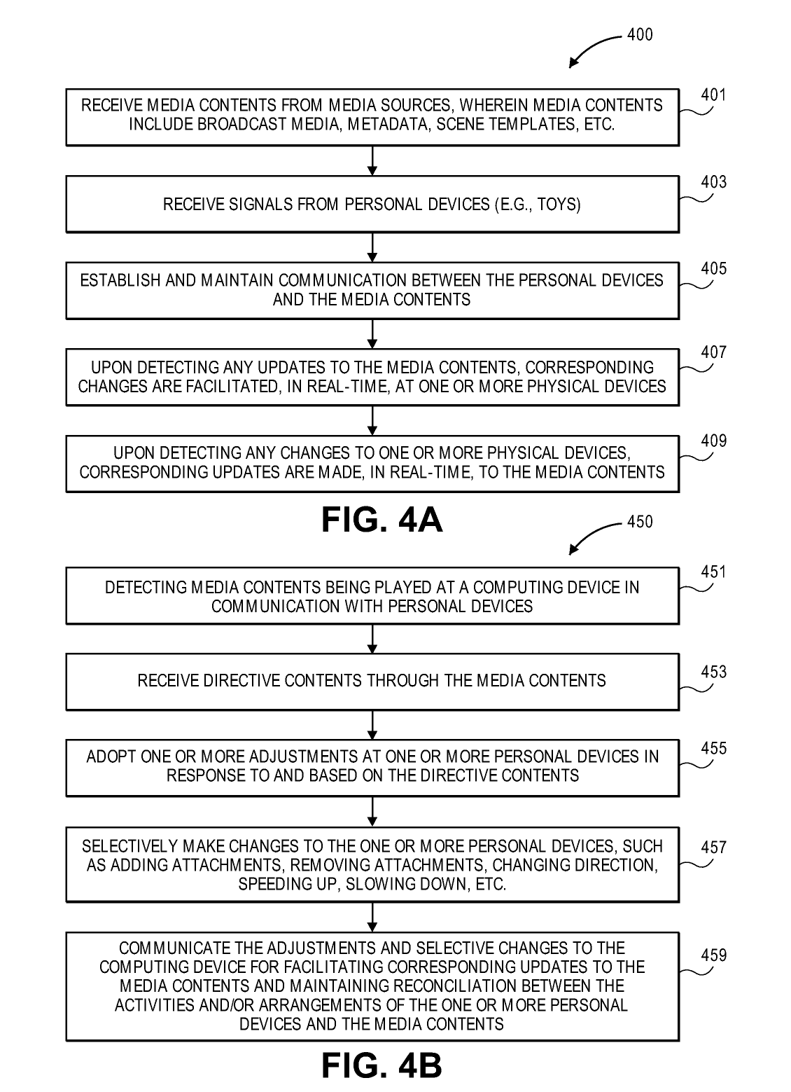

FIG. 4A illustrates a method 400 for facilitating real-time media play and interaction between media and personal devices according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by media mechanism 110 of FIG. 2. The processes of method 400 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 400 begins at block 401 with receiving media contents from media sources, wherein media contents include broadcast media, metadata, scene templates, etc. At block 403, signals from personal devices (e.g., toys) are received. At block 405, communication between the personal devices and the media contents is established and maintained. At block 407, upon detecting any changes to the media contents (e.g., speeding up or slowing down of a character, moving to a next episode/version, etc.), corresponding changes are facilitated, in real-time, at one or more physical devices (e.g., speeding up or slowing down of the corresponding toy, sending instructions to change to a different toy, etc.). At block 409, upon detecting changes to one or more physical devices (e.g., putting on or taking off of attachments), corresponding changes are facilitated, in real-time, at the media contents (e.g., moving forward or backwards in terms of dialogs, scenes, episodes, versions, etc.).

FIG. 4B illustrates a method 450 for facilitating real-time media play and interaction between media and personal devices according to one embodiment. Method 450 may be performed by processing logic that may comprise hardware (e.g., circuitry, dedicated logic, programmable logic, etc.), software (such as instructions run on a processing device), or a combination thereof. In one embodiment, method 450 may be performed by media engine 270 of FIG. 2. The processes of method 450 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 450 begins at block 451 with detection of media contents (e.g., TV show, movie, etc.) being played at a computing device (e.g., television, tablet computer, etc.) at personal devices (e.g., toys). At block 453, directive contents (e.g., changes, instructions, commands, etc.) are received from the media contents. At block 455, one or more adjustments are adopted at one or more personal devices in response to the directive contents received from the media contents. At block 457, selectively making changes to one or more personal devices, such as adding attachments, removing attachments, changing direction, speeding up, slowing down, etc. At block 459, these selective changes made to the one or more personal devices are then communicated back to the media contents for facilitating corresponding changes at the media contents.

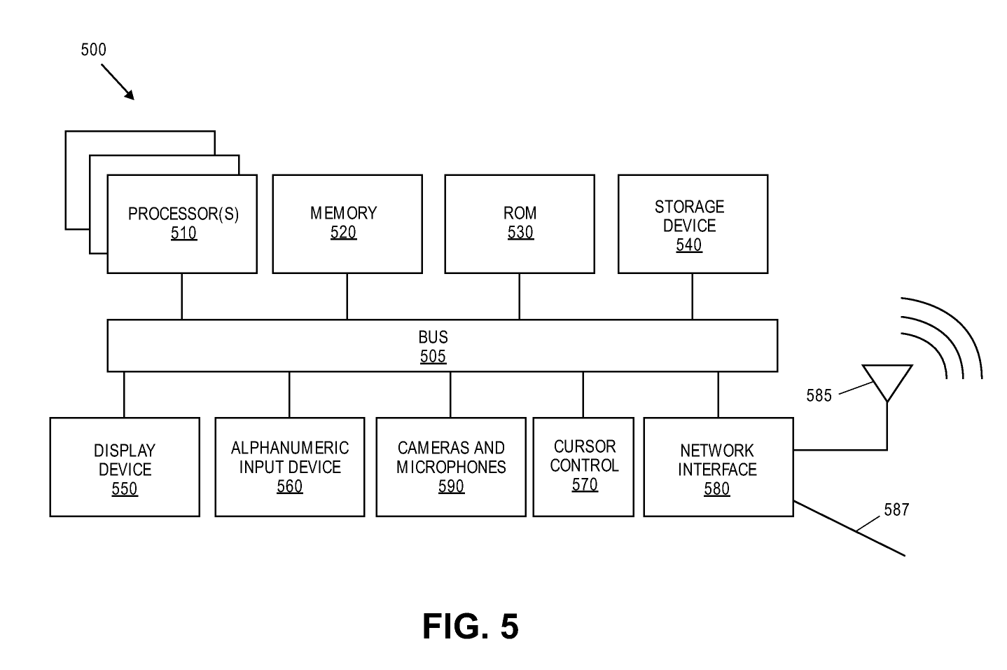

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

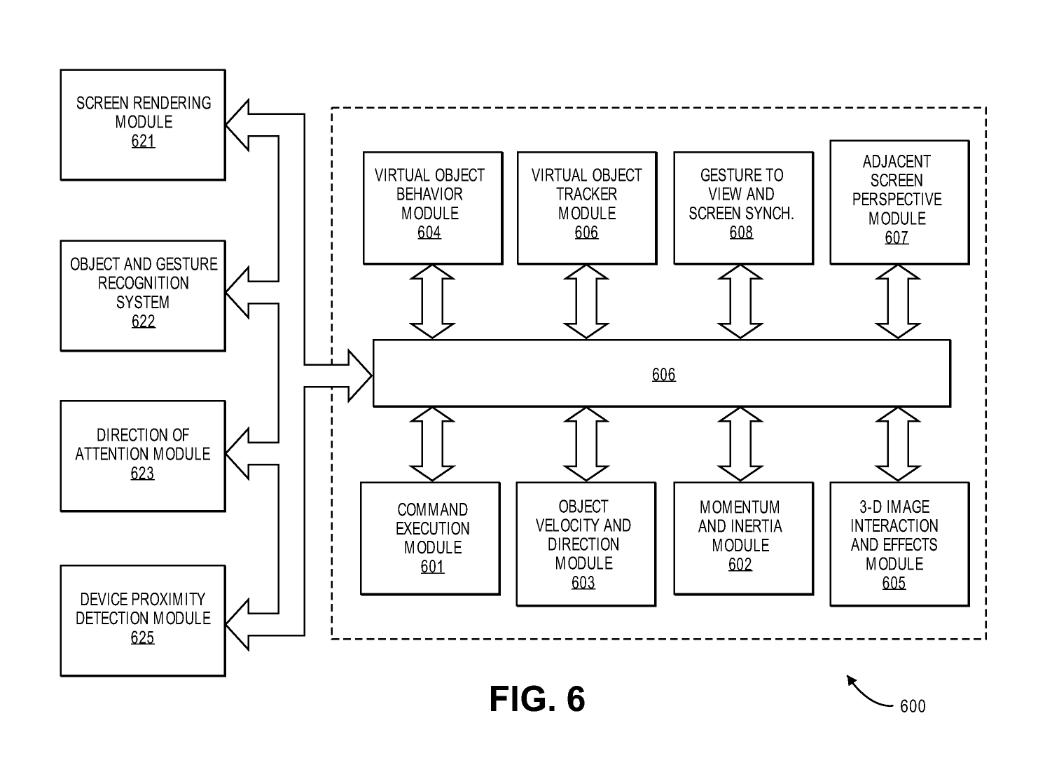

FIG. 6 illustrates an embodiment of a computing environment 600 capable of supporting the operations discussed above. The modules and systems can be implemented in a variety of different hardware architectures and form factors including that shown in FIG. 4.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three dimensional space in a vicinity of an display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate media play and real-time interaction with smart physical objects, comprising: one or more capturing/sensing components to facilitate seeking of one or more personal devices accessible to one or more users; one or more output components to present media contents; detection/reception logic to detect, in real-time, an update relating to the media contents; evaluation logic to recommend one or more revisions to activities or arrangements relating to the one or more personal devices based on the update relating to the media contents; and application/execution logic to prepare a set of instructions detailing the one or more revisions to the activities or the arrangements, wherein the application/execution logic is further to execute the set of instructions to facilitate the one or more revisions to the activities or the arrangements relating to the one or more personal devices.

Example 2 includes the subject matter of Example 1, further comprising: monitoring logic to monitor the activities or the arrangements relating to the one or more personal devices, wherein the monitoring logic is further to monitor the media contents; communication/compatibility logic to communicate the set of instructions to the one or more personal devices; and context/environment logic to detect contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

Example 3 includes the subject matter of Example 1 or 2, further comprising media buffer logic to facilitate receiving of the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet, and wherein the one or more media sources are further to generate metadata and associate the metadata with the media contents, wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

Example 4 includes the subject matter of Example 1, wherein a first revision to an activity of a first personal device comprises changing direction or speed of the first personal device, wherein a second revision to an arrangement of a second personal device comprises adding one or more attachments to the second personal device or removing one or more attachments from the second personal device, wherein the detection/reception logic is further to detect a device-level change in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

Example 5 includes the subject matter of Example 1, wherein the apparatus comprises a mobile computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

Example 6 includes the subject matter of Example 1, wherein the monitoring logic is further to monitor the activities and arrangements relating to the one or more personal devices, wherein the detection/reception logic is further to detect a new activity or a new arrangement relating to a personal device, and wherein the evaluation logic to recommend a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

Example 7 includes the subject matter of Example 6, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel.

Example 8 includes the subject matter of Example 6 or 7, wherein the recommended modification is further based on the metadata, wherein the evaluation logic to prepare or alter the recommended modification based on the metadata such that the preparation or alteration of the recommended modification triggers one or more of accompanying actions including at least one of a notification, a warning, an alert, a set of instructions, and a refusal.

Example 9 includes the subject matter of Example 6, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.

Some embodiments pertain to Example 10 that includes a method for facilitating media play and real-time interaction with smart physical objects, comprising: seeking one or more personal devices accessible to one or more users; presenting media contents; detecting, in real-time, an update relating to the media contents; recommending one or more revisions to activities or arrangements relating to the one or more personal devices based on the update relating to the media contents; preparing a set of instructions detailing the one or more revisions to the activities or the arrangements; and executing the set of instructions to facilitate the one or more revisions to the activities or the arrangements relating to the one or more personal devices.

Example 11 includes the subject matter of Example 10, further comprising: monitoring the activities or the arrangements relating to the one or more personal devices, wherein the monitoring includes monitoring the media contents; communicating the set of instructions to the one or more personal devices; and detecting contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

Example 12 includes the subject matter of Example 10 or 11, further comprising: receiving the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet; and generating metadata, and associating the metadata with the media contents, wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

Example 13 includes the subject matter of Example 10, wherein a first revision to an activity of a first personal device comprises changing direction or speed of the first personal device, wherein a second revision to an arrangement of a second personal device comprises adding one or more attachments to the second personal device or removing one or more attachments from the second personal device, and wherein a device-level change is detected in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

Example 14 includes the subject matter of Example 10, wherein the media contents are presented via a computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

Example 15 includes the subject matter of Example 10, further comprising: monitor the activities and arrangements relating to the one or more personal devices; detecting a new activity or a new arrangement relating to a personal device; and recommending a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

Example 16 includes the subject matter of Example 15, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel, and wherein the recommended modification is further based on the metadata, wherein the recommended modification is prepared or altered based on the metadata such that the preparation or alteration of the recommended modification triggers one or more of accompanying actions including at least one of a notification, a warning, an alert, a set of instructions, and a refusal.

Example 17 includes the subject matter of Example 15 or 16, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.

Example 18 includes at least one machine-readable medium comprising a plurality of instructions, when executed on a computing device, to implement or perform a method or realize an apparatus as claimed in any preceding claims or examples.

Example 19 includes at least one non-transitory machine-readable medium comprising a plurality of instructions, when executed on a computing device, to implement or perform a method or realize an apparatus as claimed in any preceding claims or examples.

Example 20 includes a system comprising a mechanism to implement or perform a method or realize an apparatus as claimed in any preceding claims or examples.

Example 21 includes an apparatus comprising means to perform a method as claimed in any preceding claims or examples.

Example 22 includes a computing device arranged to implement or perform a method or realize an apparatus as claimed in any preceding claims or examples.

Example 23 includes a communications device arranged to implement or perform a method or realize an apparatus as claimed in any preceding claims or examples.

Some embodiments pertain to Example 24 includes a system comprising a storage device having instructions, and a processor to execute the instructions to facilitate a mechanism to perform one or more operations comprising: seeking one or more personal devices accessible to one or more users; presenting media contents; detecting, in real-time, an update relating to the media contents; recommending one or more revisions to activities or arrangements relating to the one or more personal devices based on the update relating to the media contents; preparing a set of instructions detailing the one or more revisions to the activities or the arrangements; and executing the set of instructions to facilitate the one or more revisions to the activities or the arrangements relating to the one or more personal devices.

Example 25 includes the subject matter of Example 24, wherein the one or more operations further comprise: monitoring the activities or the arrangements relating to the one or more personal devices, wherein the monitoring includes monitoring the media contents; communicating the set of instructions to the one or more personal devices; and detecting contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

Example 26 includes the subject matter of Example 24 or 25, wherein the one or more operations further comprise: receiving the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet; and generating metadata, and associating the metadata with the media contents, wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

Example 27 includes the subject matter of Example 24, wherein a first revision to an activity of a first personal device comprises changing direction or speed of the first personal device, wherein a second revision to an arrangement of a second personal device comprises adding one or more attachments to the second personal device or removing one or more attachments from the second personal device, and wherein a device-level change is detected in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

Example 28 includes the subject matter of Example 24, wherein the media contents are presented via a computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

Example 29 includes the subject matter of Example 24, wherein the one or more operations further comprise: monitoring the activities and arrangements relating to the one or more personal devices; detecting a new activity or a new arrangement relating to a personal device; and recommending a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

Example 30 includes the subject matter of Example 29, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel, and wherein the recommended modification is further based on the metadata, wherein the recommended modification is prepared or altered based on the metadata such that the preparation or alteration of the recommended modification triggers one or more of accompanying actions including at least one of a notification, a warning, an alert, a set of instructions, and a refusal.

Example 31 includes the subject matter of Example 29 or 30, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.

Some embodiments pertain to Example 32 includes an apparatus comprising: means for seeking one or more personal devices accessible to one or more users; means for presenting media contents; means for detecting, in real-time, an update relating to the media contents; recommending one or more revisions to activities or arrangements relating to the one or more personal devices based on the update relating to the media contents; means for preparing a set of instructions detailing the one or more revisions to the activities or the arrangements; and means for executing the set of instructions to facilitate the one or more revisions to the activities or the arrangements relating to the one or more personal devices.

Example 33 includes the subject matter of Example 32, further comprising means for monitoring the activities or the arrangements relating to the one or more personal devices, wherein the monitoring includes monitoring the media contents; means for communicating the set of instructions to the one or more personal devices; and means for detecting contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

Example 34 includes the subject matter of Example 32 or 33, further comprising: means for receiving the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet; and generating metadata, and associating the metadata with the media contents, and wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

Example 35 includes the subject matter of Example 32, wherein a first revision to an activity of a first personal device comprises changing direction or speed of the first personal device, wherein a second revision to an arrangement of a second personal device comprises adding one or more attachments to the second personal device or removing one or more attachments from the second personal device, and wherein a device-level change is detected in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

Example 36 includes the subject matter of Example 32, wherein the media contents are presented via a computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

Example 37 includes the subject matter of Example 32, further comprising: means for monitoring activities and arrangements relating to the one or more personal devices; means for detecting a new activity or a new arrangement relating to a personal device; and means for recommending a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

Example 38 includes the subject matter of Example 32, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel, and wherein the recommended modification is further based on the metadata, wherein the recommended modification is prepared or altered based on the metadata such that the preparation or alteration of the recommended modification triggers one or more of accompanying actions including at least one of a notification, a warning, an alert, a set of instructions, and a refusal.

Example 39 includes the subject matter of Example 37 or 38, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.

Example 40 includes at least one non-transitory machine-readable medium comprising a plurality of instructions, when executed on a computing device, to implement or perform a method as claimed in any of claims or examples 10-17.

Example 41 includes at least one machine-readable medium comprising a plurality of instructions, when executed on a computing device, to implement or perform a method as claimed in any of claims or examples 10-17.

Example 42 includes a system comprising a mechanism to implement or perform a method as claimed in any of claims or examples 10-17.

Example 43 includes an apparatus comprising means for performing a method as claimed in any of claims or examples 10-17.

Example 44 includes a computing device arranged to implement or perform a method as claimed in any of claims or examples 10-17.

Example 45 includes a communications device arranged to implement or perform a method as claimed in any of claims or examples 10-17.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
one or more capturing/sensing components to facilitate seeking of one or more personal devices accessible to one or more users;
one or more output components to present media contents;
detection/reception logic to detect, in real-time, an update relating to the media contents;
evaluation logic to recommend one or more revisions to activities or arrangements relating to the one or more personal devices based on the update relating to the media contents; and
application/execution logic to prepare a set of instructions detailing the one or more revisions to the activities or the arrangements, wherein the application/execution logic is further to execute the set of instructions to facilitate the one or more revisions to the activities or the arrangements relating to the one or more personal devices.

2. The apparatus of claim 1, further comprising:
monitoring logic to monitor the activities or the arrangements relating to the one or more personal devices, wherein the monitoring logic is further to monitor the media contents;
communication/compatibility logic to communicate the set of instructions to the one or more personal devices; and
context/environment logic to detect contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

3. The apparatus of claim 1, further comprising media buffer logic to facilitate receiving of the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet, and
wherein the one or more media sources are further to generate metadata and associate the metadata with the media contents, wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

4. The apparatus of claim 1, wherein a first revision to an activity of a first personal device comprises changing direction or speed of the first personal device, wherein a second revision to an arrangement of a second personal device comprises adding one or more attachments to the second personal device or removing one or more attachments from the second personal device,
wherein the detection/reception logic is further to detect a device-level change in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

5. The apparatus of claim 1, wherein the apparatus comprises a mobile computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

6. The apparatus of claim 1, wherein the monitoring logic is further to monitor the activities and arrangements relating to the one or more personal devices,
wherein the detection/reception logic is further to detect a new activity or a new arrangement relating to a personal device, and
wherein the evaluation logic to recommend a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

7. The apparatus of claim 6, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel.

8. The apparatus of claim 7, wherein the recommended modification is further based on the metadata, wherein the evaluation logic to prepare or alter the recommended modification based on the metadata such that the preparation or alteration of the recommended modification triggers one or more of accompanying actions including at least one of a notification, a warning, an alert, a set of instructions, and a refusal.

9. The apparatus of claim 6, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.

10. A method comprising:
seeking one or more personal devices accessible to one or more users;
presenting media contents;
detecting, in real-time, an update relating to the media contents;
recommending one or more revisions to activities or arrangements relating to the one or more personal devices based on the update relating to the media contents;
preparing a set of instructions detailing the one or more revisions to the activities or the arrangements; and
executing the set of instructions to facilitate the one or more revisions to the activities or the arrangements relating to the one or more personal devices.

11. The method of claim 10, further comprising:
monitoring the activities or the arrangements relating to the one or more personal devices, wherein the monitoring includes monitoring the media contents;
communicating the set of instructions to the one or more personal devices; and
detecting contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

12. The method of claim 10, further comprising:
receiving the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet; and
generating metadata, and associating the metadata with the media contents, wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

13. The method of claim 10, wherein a first revision to an activity of a first personal device comprises changing direction or speed of the first personal device, wherein a second revision to an arrangement of a second personal device comprises adding one or more attachments to the second personal device or removing one or more attachments from the second personal device,
wherein a device-level change is detected in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

14. The method of claim 10, wherein the media contents are presented via a computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

15. The method of claim 10, further comprising:
monitoring the activities and arrangements relating to the one or more personal devices;
detecting a new activity or a new arrangement relating to a personal device; and
recommending a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

16. The method of claim 15, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel,
wherein the recommended modification is further based on the metadata, wherein the recommended modification is prepared or altered based on the metadata such that the preparation or alteration of the recommended modification triggers one or more of accompanying actions including at least one of a notification, a warning, an alert, a set of instructions, and a refusal.

17. The method of claim 16, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.

18. At least one machine-readable medium comprising a plurality of instructions, executed on a computing device, to facilitate the computing device to perform one or more operations comprising:
seeking one or more personal devices accessible to one or more users;
presenting media contents;
detecting, in real-time, an update relating to the media contents;
recommending one or more revisions to activities or arrangements relating to the one or more personal devices based on the update relating to the media contents;
preparing a set of instructions detailing the one or more revisions to the activities or the arrangements; and
executing the set of instructions to facilitate the one or more revisions to the activities or the arrangements relating to the one or more personal devices.

19. The machine-readable medium of claim 18, wherein the one or more operations further comprise:
monitoring the activities or the arrangements relating to the one or more personal devices, wherein the monitoring includes monitoring the media contents;
communicating the set of instructions to the one or more personal devices; and
detecting contextual variations relating to the one or more users or environmental variations relating to the one or more personal devices, wherein the contextual and environmental variations are based on one or more factors including at least one of user preferences, user health, user age, ambient light, weather, background view, available play space, historical data, brand the one or more personal devices, system limitations of the one or more personal devices, and speed or condition of the one or more personal devices.

20. The machine-readable medium of claim 18, wherein the one or more operations further comprise:
receiving the media contents from one or more media sources over one or more networks, wherein the one or more media sources comprise one or more of broadcasting companies, media production companies, media distribution companies, broadcasting channels, cable broadcasters, satellite broadcasters, media players, and websites, and wherein the one or more networks comprise one or more of a Cloud network, a proximity network, an intranet, and the Internet; and
generating metadata, and associating the metadata with the media contents, wherein the one or more media sources are further to store the metadata, wherein the metadata is generated and associated, automatically or manually, at various stages including at least one of pre-production, production, post-production, broadcast, and post-broadcast, wherein the metadata is, automatically or manually, modified or further associated with the media contents based on one or more real-time factors including at least one of contextual variations and environmental variations.

21. The machine-readable medium of claim 18, wherein a first revision to an activity of a first personal device comprises changing direction or speed of the first personal device, wherein a second revision to an arrangement of a second personal device comprises adding one or more attachments to the second personal device or removing one or more attachments from the second personal device,
wherein a device-level change is detected in the activities or the arrangements of the one or more personal devices, and wherein the evaluation logic is further to recommend a content modification plan for the media contents, wherein the application/execution logic is further to prepare and execute the modification plan to facilitate the recommended content modification to the media contents to correspond to the device-level change to the activities or the arrangements of the one or more personal devices.

22. The machine-readable medium of claim 18, wherein the media contents are presented via a computing device including one or more of smartphones, tablet computers, laptops, head-mounted displays, head-mounted gaming displays, wearable glasses, wearable binoculars, smart jewelry, smart watches, smartcards, and smart clothing items, and wherein the one or more personal devices comprise one or more smart personal devices including at least one of toys, games, office equipment, sports gear, work tools, and household items.

23. The machine-readable medium of claim 18, wherein the one or more operations further comprise:
monitoring the activities and arrangements relating to the one or more personal devices;
detecting a new activity or a new arrangement relating to a personal device; and
recommending a modification in the media contents based on the new activity or the new arrangement, wherein the modification in the media contents is proposed to reconcile the media contents with the new activity or the new arrangement, wherein the recommended modification in the media contents represents consistency with the new activity or the new arrangement.

24. The machine-readable medium of claim 23, wherein the recommended modification in the media contents comprises one or more of turning off or pausing the media contents, increasing or decreasing volume, queuing up or backing up to a subsequent portion or a preceding portion, respectively, of the media contents or a scene within a current portion of the media contents, and switching to another movie, program, or channel,
wherein the recommended modification is further based on the metadata, wherein the recommended modification is prepared or altered based on the metadata such that the preparation or alteration of the recommended modification triggers one or more of accompanying actions including at least one of a notification, a warning, an alert, a set of instructions, and a refusal.

25. The machine-readable medium of claim 24, wherein the new arrangement comprises at least of adding one or more new components to the physical device, removing one or more existing components from the physical device, wherein each component of the one or more new components and the one or more existing components includes an identification tag to communicate identification or verification data relating to the one or more new and existing components to maintain reconciliation between the media contents and the new activity or the new arrangement relating to the physical device.
